(19) United States
(12) Patent Application Publication
(10) Pub. No.: US 2006/0292987 A1
(43) Pub. Date: Dec. 28, 2006

(54) Method of wireless local area network and Bluetooth network coexistence in a collocated device

(76) Inventors: Lior Ophir, Herzlia (IL); Arik Klein, Rishon-Lezion (IL); Itay Sherman, Raanan (IL); Yigal Bitran, Tel-Aviv (IL)

Correspondence Address: TEXAS INSTRUMENTS INCORPORATED, P O BOX 655474, M/S 3999, DALLAS, TX, 75265, US

(21) Appl. No.: 11/167,619

(22) Filed: Jun. 27, 2005

(51) Int. Cl. H04B 7/00; H04M 1/00

(52) U.S. Cl. 455/41.2; 455/552.1

(57) ABSTRACT

A collated wireless local area network/Bluetooth (WLAN/BT) device avoids radio interference between the two wireless systems by collaborative coexistence mechanisms. The collocated WLAN/BT device and coexistence methods include time division multiplexing based on various operating states of the collocated WLAN and BT systems, respectively. Such operating states include the transmission of low priority WLAN and BT data signals during WLAN and BT periods, the sleep mode of the collocated WLAN system, transmission of high priority data signals from the collocated BT system during time division multiplexed WLAN and BT periods, the transition of the collocated BT system from an active state to an idle state, and the transition of the collocated WLAN system from an active state to an idle state.

### CROSS REFERENCE TO RELATED APPLICATIONS

None

### FIELD OF INVENTION

The present invention generally relates to a collocated wireless local area network/Bluetooth (WLAN/BT) device that avoids radio interference between the two wireless systems by collaborative coexistence mechanisms. Particularly, the present invention relates to a collocated WLAN/BT device and coexistence methods that include time division multiplexing based on various operating states of the collocated WLAN and BT systems, respectively.

### BACKGROUND OF THE INVENTION

The Institute of Electronic and Electrical Engineer's (IEEE's) 802.11 standards for wireless local area networks (WLANs) and the Bluetooth (BT) specifications for wireless personal area networks (WPANs) are the leading wireless networking technologies. As the size and power requirements of both WLAN and BT devices become smaller, both technologies are finding their way into a growing number of mobile devices, such as cellphones, smartphones, personal digital assistants (PDAs), and laptop computers. Both 802.11 WLANs and BT WPANs utilize the unlicensed 2.4-2.5 GHz Industrial Scientific Medical (ISM) radio frequency band, resulting in potential radio interference between these two wireless networking technologies. For example, when a WLAN radio transceiver and a BT radio transceiver are collocated in the same device, radio interference can become a severe problem.

The IEEE 802.11b and 802.11g WLAN standards specify a physical layer that transmits data using a direct sequence spread spectrum (DSSS) with quaternary phase-shift keying or complementary code keying at 11 Mbps and orthogonal frequency division multiplexing at 54 Mbps, respectively. WLAN transmission at, for example, 11 Mbps, represents a raw data rate of transmission. In such a WLAN system, protocol overheads for the Transmission Control Protocol (TCP) and Internet Protocol (IP) for network communications, as well as the Media Access Control (MAC) overhead of the WLAN system's communications, result in an actual transmission rate of up to about 5 Mbps for a single WLAN communication link.

In the US, the Federal Communications Commission divides the 2.4 GHz ISM band into 11 adjacent channels of 5 MHz from 2.412-2.462 GHz for Direct Sequence Spread Spectrum (DSSS) wireless technologies. Since a single 802.11b WLAN channel has a bandwidth of about 16 MHz at 20 dB, using adjacent channels would result in severe radio interference. For this reason, WLANs that operate in proximity to one another are typically operated on channels 1, 6, and 11 with an interchannel interval of 25 MHz to prevent radio interference among the WLANs.

The BT standard is based on a frequency hopping spread spectrum (FHSS) technology. At any point in time, the BT communication signal occupies only 1 MHz of bandwidth. Over time, the signal changes its center frequency, i.e., hops, between 79 center frequencies, equally spaced between 2.402 GHz and 2.480 GHz of the ISM band. Hence, over time the BT signal actually occupies a bandwidth of 79 MHz of the available 83.5 MHz of the 2.4 GHz ISM band.

The BT standard version 1.1 is a Time Division Multiplexed (TDM) system, where the basic unit of operation is a time slot of 625 μs duration. All BT system transmissions or receptions occur in 1, 3, or 5 time slots, in which each time slot is occupied by a communication packet. During communication between a BT master device and BT slave device in a wireless Personal Area Network (WPAN), a transmission packet and a reception packet are joined together in a pair to provide a communication link. The paired time slots of the BT master device comprise a transmission time slot followed immediately by a reception time slot, while the synchronized and corresponding paired time slots of the BT slave device comprise a reception time slot followed immediately by a transmission time slot. Every BT signal packet transmitted by the master device must be received by the slave device and acknowledged by a transmission from the slave device back to the master device during the corresponding reception time slot of the master device. Hence, communication links between master and slave BT devices may comprise packet pairs of 2, 4, 6, 8, or 10 time slots in duration.

Since a BT device hops over 78 MHz of the ISM band and an 802.11 WLAN device requires approximately 16 MHz of bandwidth within the ISM band, it is not possible to simultaneously operate both BT and WLAN devices in the same area without radio interference.

Coexistence is a technique that is designed to reduce radio interference, and in turn, enhance performance, of both BT and WLAN devices operating in the same area. Within the context of coexistence, BT and WLAN devices can be “collocated” or “non-collocated.” Collocated means that a BT and a WLAN system reside in the same device, i.e, the two systems are collocated. Within the collocated device, the electrical isolation between the BT and WLAN transmission signals can be as low as 10 dB.

The requirements for a coexistence protocol, i.e., a protocol for a collocated device, are: (1) the collocated device will ensure undisturbed BT high priority traffic, for example, real-time voice communications; (2) the collocated device will maintain fairness between non-voice BT communication, for example, low priority data signals, and WLAN communication; (3) if the BT system does not have traffic, then WLAN performance should not be impacted; and (4) if the WLAN system does not have traffic, then BT performance should not be impacted.

A coexistence solution for a collocated WLAN and BT device may be provided by using, for example, Texas Instruments' TNETW1100b WLAN processors and Texas Instruments' BRF6100 or BRF6150 single chip BT systems. When used in a collocated device, the WLAN processor acts as a coexistence master. The coexistence master has internal knowledge of the state of the WLAN system and it has knowledge of the state of the BT system via a hardware coexistence interface. The WLAN coexistence master also controls the BT system's transmission. The coexistence mechanism is collaborative and is based on time division multiplexing (TDM), which allows for sharing of time, and hence, of the wireless medium, between the BT system and the WLAN system.

As shown in FIG. 1, the basic algorithm for this TDM coexistence mechanism toggles repeatedly between a WLAN period of T_{WLAN} milliseconds, designated for WLAN communication, and a BT period of T_{BT} milliseconds, designated for BT communication. These periods are configurable and can be optimized for each of the wireless technologies. In order to ensure fairness between the BT and WLAN systems, it is recommended that the same duration periods for each system be used, i.e., T_{WLAN}=T_{BT}. In addition, if there is no BT traffic, then in order not to impact performance of the WLAN system, WLAN operation is allowed during BT periods. Similarly, if there is no WLAN traffic, then in order not to impact the performance of the BT system, BT operation is allowed during WLAN periods.

Without a coexistence mechanism for a collocated device, experimental results indicate that a collocated BT system is usually able to operate at 80-90% of its baseline performance; however, this comes at the expense of very poor WLAN performance, i.e., <20% of its baseline performance. In the real world, this often results in termination of the WLAN application as soon as a BT connection is formed. In general, BT usually harms the WLAN operation more than the other way around. In some cases, however, operation of collocated WLAN and BT systems without coexistence may result in disconnection of the BT link. Altogether, without coexistence, user acceptable BT and WLAN operation cannot be guaranteed.

When the coexistence mechanism described above is used, user acceptable collocated BT and WLAN operation may be achieved. In this case, each technology operates at about 60% of its baseline performance. In many cases, the actual data rate of communication for the two systems is not limited by the wireless network, but rather by other limiting factors, for example, broadband access pipe and host processor speed.

There remains a need to further enhance the coexistence mechanism described above, to assure acceptable coexistence: during the transmission of low priority WLAN and BT data signals in a collocated WLAN/BT device; during the sleep mode of the collocated WLAN system; during the transmission of high priority data signals from the collocated BT system during time division multiplexed WLAN and BT periods; during the transition of the collocated BT system from an active state to an idle state; and during the transition of the collocated WLAN system from an active state to an idle state.

### SUMMARY OF THE INVENTION

An aspect of an exemplary embodiment of the present invention provides a collocated wireless local area network/Bluetooth (WLAN/BT) device that comprises a WLAN system including a coexistence master, a BT system including a timing block, which signals a state of the BT system, a BT radio shut-down signal output from the coexistence master to the BT system, a timing signal output from the BT system to the coexistence master of the WLAN system, the timing signal indicating a state corresponding to either transmission or reception by the BT system, and an algorithm residing in the coexistence master in which the algorithm provides time division multiplexing of BT and WLAN signals to avoid radio interference.

Another aspect of an exemplary embodiment of the present invention provides a method of wireless local area network/Bluetooth (WLAN/BT) coexistence for a collocated WLAN/BT device. The method comprises time division multiplexing of WLAN and BT transmissions from a collocated WLAN system and a collocated BT system, respectively, the time division multiplexing including a WLAN period and a BT period, in which during the WLAN period, transmission and reception of frames from an access point to the collocated WLAN system and from the collocated WLAN system to the access point are allowed, while transmissions by the collocated BT system are not allowed, and during the BT period, transmission and reception of packets by the collocated BT system are allowed, while the collocated WLAN system acknowledges receipt of frames from the access point.

Yet another aspect of an exemplary embodiment of the present invention provides a method of wireless local area network/Bluetooth (WLAN/BT) coexistence for a collocated WLAN/BT device. The method comprises time division multiplexing of WLAN and BT transmissions from a collocated WLAN system and a collocated BT system, respectively, the time division multiplexing including a WLAN period and a BT period, in which the WLAN period corresponds to a sleep state and the collocated BT system transmits during the WLAN period corresponding to a sleep state.

Yet another aspect of an exemplary embodiment of the present invention provides a method of wireless local area network/Bluetooth (WLAN/BT) coexistence for a collocated WLAN/BT device. The method comprises time division multiplexing of WLAN and BT transmissions from a collocated WLAN system and a collocated BT system, respectively, the time division multiplexing including a WLAN period and a BT period, in which during the WLAN period, a high priority data signal from the collocated BT system causes transmission of the collocated WLAN system to be disabled and transmission/reception of the collocated BT system to be enabled.

Yet another aspect of an exemplary embodiment of the present invention provides a method of wireless local area network/Bluetooth (WLAN/BT) coexistence for a collocated WLAN/BT device. The method comprises time division multiplexing of WLAN and BT transmissions from a collocated WLAN system and a collocated BT system, respectively, the time division multiplexing including a WLAN period and a BT period, in which during the WLAN period, a high priority data signal from the collocated BT system causes the collocated WLAN system to enter a power-save mode and transmission/reception of the collocated BT system to be enabled.

Yet another aspect of an exemplary embodiment of the present invention provides a method of wireless local area network/Bluetooth (WLAN/BT) coexistence for a collocated WLAN/BT device. The method comprises time division multiplexing of WLAN and BT transmissions from a collocated WLAN system and a collocated BT system, respectively, the time division multiplexing including a WLAN period and a BT period, in which during a BT period, the collocate BT system is idle and the collocated WLAN system transmits.

Yet another aspect of an exemplary embodiment of the present invention provides a method of wireless local area network/Bluetooth (WLAN/BT) coexistence for a collocated WLAN/BT device. The method comprises time division multiplexing of WLAN and BT transmissions from a collocated WLAN system and a collocated BT system, respectively, the time division multiplexing including a WLAN period and a BT period, in which during a WLAN period, the collocated WLAN is idle and the collocated BT system transmits.

### BRIEF DESCRIPTION OF THE DRAWINGS

Exemplary embodiments of the present invention are discussed below in reference to the drawings, in which:

FIG. 1 illustrates a timing diagram of a time division multiplexed coexistent system for a collocated WLAN/BT system;

FIG. 2 illustrates a block diagram of a collocated WLAN/BT device in an exemplary embodiment of the present invention;

FIG. 3 illustrates a timing diagram of a collocated WLAN/BT device for low priority data signals in an exemplary embodiment of the present invention;

FIG. 4 illustrates a timing diagram of a collocated WLAN/BT device for low priority data signals during WLAN active and WLAN sleep modes in an exemplary embodiment of the present invention;

FIG. 5 illustrates a timing diagram of a collocated WLAN/BT device for high priority BT data signals, for example, voice communications, during WLAN and BT periods in an exemplary embodiment of the present invention;

FIG. 6 illustrates a timing diagram of a collocated WLAN/BT device for the transition from a BT active state to a BT idle state during corresponding WLAN and BT periods in an exemplary embodiment of the present invention; and

FIG. 7 illustrates a timing diagram of a collocated WLAN/BT device for the transition from a WLAN active state to a WLAN idle state during corresponding WLAN and BT periods in an exemplary embodiment of the present invention

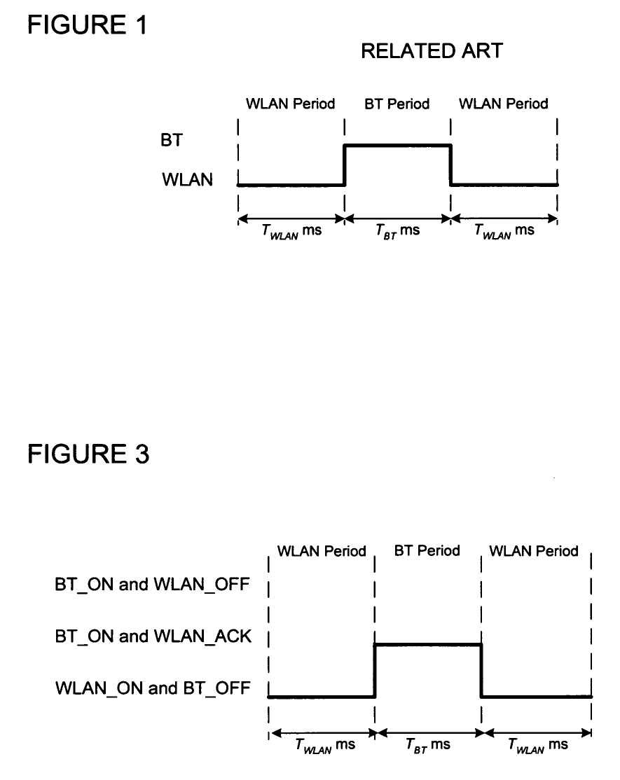

### DETAILED DESCRIPTION OF EXEMPLARY EMBODIMENTS OF THE INVENTION

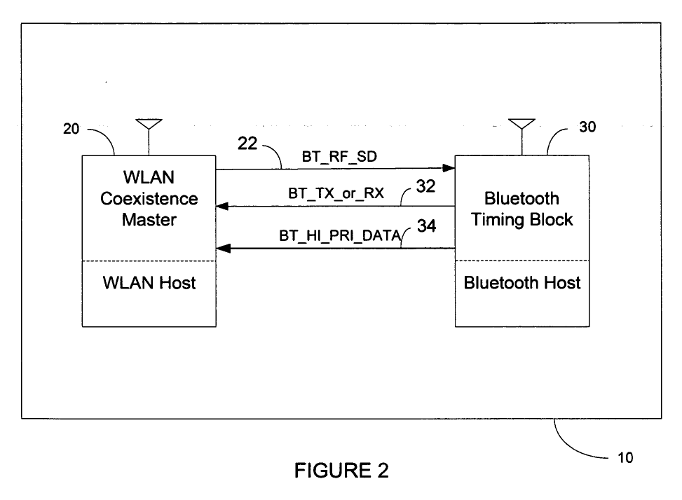

FIG. 2 illustrates an exemplary embodiment of the present invention that may comprise a collocated WLAN/BT device 10 including a WLAN system 20 and a BT system 30. The WLAN system may include a WLAN coexistence master that determines the state of transmission and reception of the WLAN system 20 based on internal knowledge of the WLAN system 20 and may include a BT system 30 that may provide timing signals for transmission and reception of the BT system 30. The WLAN coexistence master of the WLAN system 20 may provide a signal, for example, BT_RF_SD 22, to the BT system 30 that shuts down the BT system's radio frequency transmissions according to an algorithm, which implements the coexistence mechanism. The BT system 30 may provide a timing signal, for example, BT_TX_or_RX 32, to the WLAN system 20 that may indicate the BT system 30 transmitting or receiving a BT signal. In various exemplary embodiments, The BT system 30 may provide a signal, for example, BT_HI_PRI_DATA 34, that may indicate the BT system 30 is transmitting or receiving high priority data, for example, voice.

FIG. 3 illustrates an exemplary embodiment of the present invention in which low priority data transmissions for both the WLAN and BT systems of the collocated WLAN/BT device may be time division multiplexed. During the designated WLAN periods, transmission and reception of management, control, and data frames from the access point to the collocated WLAN system and from the collocated WLAN system to the access point may be allowed, while transmission by the collocated BT system may not be allowed. During the designated BT periods, transmission and reception of BT signal packets by the collocated BT device may be allowed, while the collocated WLAN system may receive downstream signals from the access point and acknowledge receipt of such signals to the access point. During a designated BT period, it may be possible that downstream signals from the access point to the collocated WLAN system may not interfere with BT signals because the WLAN transmission frequency bands and times may not overlap with the BT signals. In the case where the WLAN access point may detect that the medium, i.e., the WLAN transmission frequency band, is busy with a BT signal, the access point may buffer the data for subsequent transmission. Acknowledgement frames from the collocated WLAN system may be of short duration and may minimally impact BT communications. In various exemplary embodiments of the present invention, the periods T_{WLAN} and T_{BT} of FIG. 3 may be approximately equal and may each be approximately equal to 20 ms.

A WLAN system may decrease the rate of signal transmission by a rate fallback mechanism after a number of unsuccessful communications to improve communications. However, during a designated BT period of an exemplary embodiment of the invention, it is possible that a number of WLAN transmission attempts may be unsuccessful. In this case, decreasing the rate of WLAN signal transmission does not offer a solution to the number of unsuccessful WLAN communications. Hence, in various exemplary embodiments of the invention, a rate fallback mechanism of the WLAN system may be disabled in a collocated WLAN/BT device during periods in which the collocated BT system may transmit.

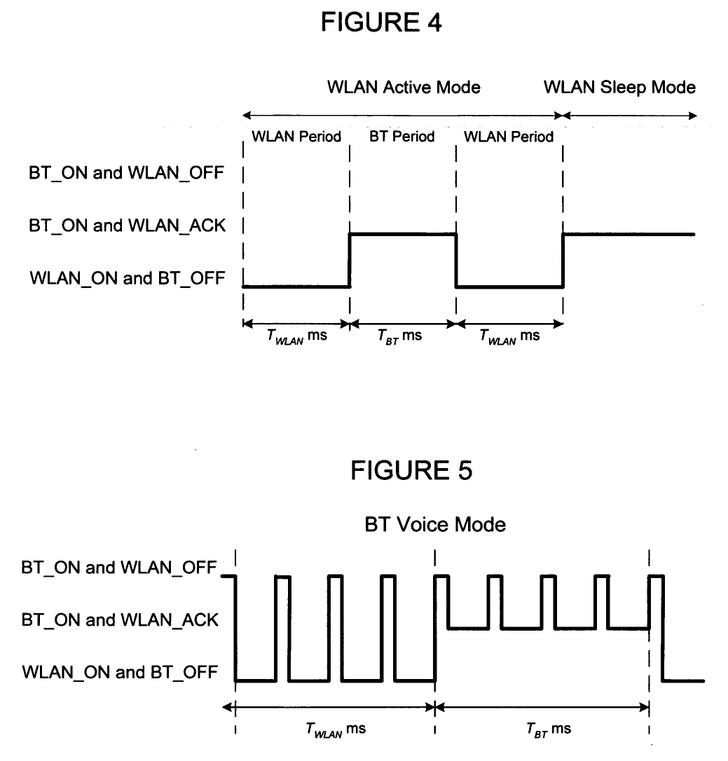

FIG. 4 illustrates an exemplary embodiment of the present invention in which low priority data transmissions of the BT system of the collocated WLAN/BT device may be allowed during extended periods while the collocated WLAN system is sleeping. The collocated WLAN system may have knowledge of its internal state and may allow transmissions by the collocated BT system when the collocated WLAN system is in a sleep mode. The sleeping WLAN system may continue to listen for beacon frames from the access point indicating that buffered data is awaiting transmission to the collocated system and upon receipt of such a beacon frame may wake up and resume the WLAN/BT coexistence mechanism illustrated by FIG. 3. Alternatively, the host WLAN system may require the collocated WLAN system to awaken and to transmit a Power Save (PS)-Poll frame to the access point in order to transmit data upstream. In this case, the collocated WLAN system may also resume the coexistence mechanism illustrated in FIG. 3. In various exemplary embodiments of the invention, BT transmissions may be turned off during the wake-up procedures of the collocated WLAN system.

FIG. 5 illustrates an exemplary embodiment of the present invention in which high priority data communications, for example, voice communications, of the BT system of the collocated WLAN/BT device may be allowed during a designated WLAN period. The collocated BT system may have knowledge of its internal state and may transmit a signal indicating a state corresponding to a high priority communication to the collocated WLAN system via a signal line, for example, BT_HI_PRI_DATA, as shown in FIG. 2. Upon receipt of a signal indicating a high priority BT communication, timing information from a BT timing block of the collocated BT system (see, FIG. 2) may also be signaled to the collocated WLAN system via the signal line. The collocated WLAN system may then enter a power-save mode, associated with the coexistence mechanism, which may turn off WLAN transmissions during the timed periods of high priority BT communications.

Wireless personal area networks (WPANs) may comprise several BT systems including the BT system of the collocated device. In various exemplary embodiments of the invention, as additional BT devices are added to a WPAN including the collocated BT system, the collocated BT system may designate the BT signaling, for example, page, page scan, and master-slave switch information required for the build-up of the WPAN, as a high priority BT communication, to allow the WPAN build-up to occur without transmission interference from the collocated WLAN system.

The collocated BT system may be in a low power mode that comprises “sniffs” at known timing intervals, to “sniff” for other BT systems belonging to the WPAN with which the collocated BT system is associated. In various exemplary embodiments of the invention, the collocated BT system may designate the sniff as a high priority BT communication, to allow BT communications to occur without transmission interference from the collocated WLAN system.

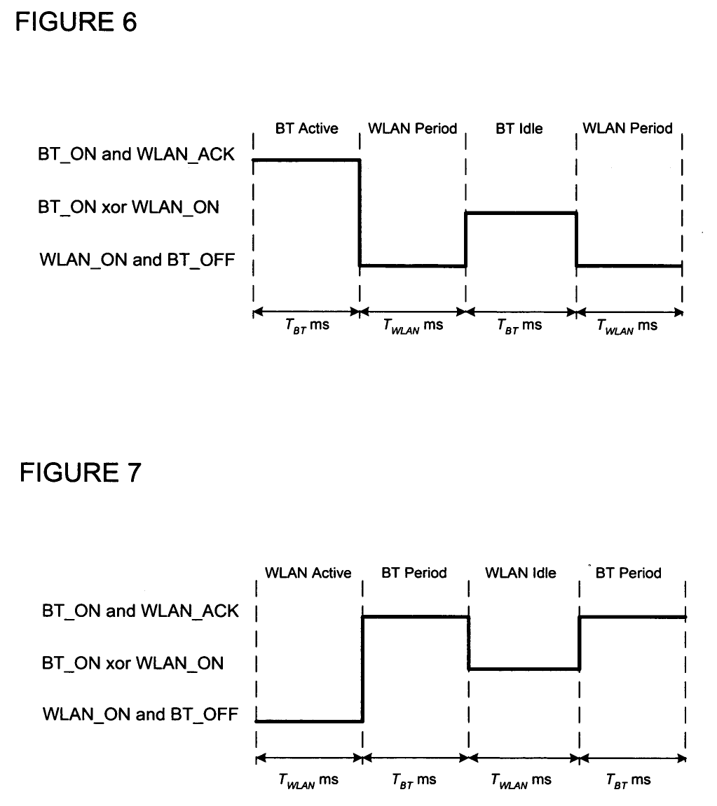

FIG. 6 illustrates an exemplary embodiment of the present invention in which a BT system of the collocated WLAN/BT device transitions from active to idle, i.e., a power-save mode. During the designated BT active period, transmission and reception of BT signal packets by the collocated BT device may be allowed, while the collocated WLAN system may receive downstream signals from the access point and acknowledge receipt of such signals to the access point. Also, during or following this designated BT active period, the collocated BT system may initiate an idle or power-save mode. In various exemplary embodiments, the state of this BT idle mode may be signaled to the coexistence master of the collocated WLAN system via a signal line. Following a designated WLAN period, the designated BT idle period of FIG. 6 may allow, for example, either BT wake-up procedures including page, page scan, and master-slave switch information or sniffs by the collocated BT system. When there is no activity by the collocated BT system in idle mode, the WLAN system may transmit freely. However, during the designated BT idle period, only one of the two collocated systems, i.e., WLAN or BT, may transmit at one time. This exclusive-or relationship between the collocated BT and WLAN transmissions may depend on the signaling of the BT state of activity to the coexistence master of the WLAN system via a signal line in the collocated WLAN/BT device.

FIG. 7 illustrates an exemplary embodiment of the present invention in which a WLAN system of the collocated WLAN/BT device transitions from active to idle, i.e., a power-save mode. During the designated WLAN periods, transmission and reception of management, control, and data frames from the access point to the collocated WLAN system and from the collocated WLAN system to the access point may be allowed, while transmission by the collocated BT system may not be allowed. Also, during or following this designated WLAN active period, the collocated WLAN system may initiate an idle or power-save mode. Following a designated BT period, the designated WLAN idle period of FIG. 7 may allow, for example, either WLAN wake-up procedures including, for example, a PS (Power Save)-Poll frame to be transmitted page and/or listening by the collocated WLAN system for Beacon frames from the access point. When there is no activity by the collocated WLAN system in idle mode, the BT system may transmit freely. However, during the designated WLAN idle period, only one of the two collocated systems, i.e., WLAN or BT, may transmit at one time.

Because many varying and different exemplary embodiments may be made within the scope of the inventive concepts taught above and because many modifications may be made in the exemplary embodiments detailed above, in accordance with the descriptive requirements of the law, it is understood that the detailed descriptions exemplified above are to be interpreted as illustrative and not in a limiting sense.

What is claimed:

1. A collocated wireless local area network/Bluetooth (WLAN/BT) device, comprising:
a WLAN system including a coexistence master;
a BT system including a timing block, which signals a state of the BT system;
a BT radio shut-down signal output from the coexistence master to the BT system;
a timing signal output from the BT system to the coexistence master of the WLAN system, the timing signal indicating a state corresponding to either transmission or reception by the BT system; and
an algorithm residing in the coexistence master, the algorithm providing time division multiplexing of BT and WLAN signals to avoid radio interference.

2. The collocated WLAN/BT device of claim 1, further comprising:
a high priority data signal output from the BT system to the coexistence master of the WLAN system, the high priority data signal indicating that transmissions by the WLAN system are disabled.

3. A method of wireless local area network/Bluetooth (WLAN/BT) coexistence for a collocated WLAN/BT device, the method comprising:
time division multiplexing of WLAN and BT transmissions from a collocated WLAN system and a collocated BT system, respectively, the time division multiplexing including a WLAN period and a BT period, wherein
during the WLAN period, transmission and reception of frames from an access point to the collocated WLAN system and from the collocated WLAN system to the access point are allowed, while transmissions by the collocated BT system are not allowed, and
during the BT period, transmission and reception of packets by the collocated BT system are allowed, while the collocated WLAN system acknowledges receipt of frames from the access point.

4. The method of claim 3, wherein the WLAN period and the BT period are approximately equal.

5. The method of claim 4, wherein the WLAN period and the BT period are approximately 20 ms.

6. The method of claim 3, further comprising disabling a rate fallback mechanism of the collocated WLAN system during a BT period.

7. A method of wireless local area network/Bluetooth (WLAN/BT) coexistence for a collocated WLAN/BT device, the method comprising:
time division multiplexing of WLAN and BT transmissions from a collocated WLAN system and a collocated BT system, respectively, the time division multiplexing including a WLAN period and a BT period, wherein
the WLAN period corresponds to a sleep state and the collocated BT system transmits during the WLAN period corresponding to a sleep state.

8. The method of claim 7, wherein
the collocated WLAN system listens for beacon frames from an access point during the sleep state.

9. The method of claim 7, wherein
the collocated WLAN system awakens during the WLAN period corresponding to a sleep state and disables transmissions by the collocated BT system.

10. A method of wireless local area network/Bluetooth (WLAN/BT) coexistence for a collocated WLAN/BT device, the method comprising:
time division multiplexing of WLAN and BT transmissions from a collocated WLAN system and a collocated BT system, respectively, the time division multiplexing including a WLAN period and a BT period, wherein
during the WLAN period, a high priority data signal from the collocated BT system causes transmission of the collocated WLAN system to be disabled and transmission/reception of the collocated BT system to be enabled.

11. The method of claim 10, wherein
the high priority data signal includes timing information of subsequent BT transmissions/receptions from a timing block of the collocated BT system.

12. A method of wireless local area network/Bluetooth (WLAN/BT) coexistence for a collocated WLAN/BT device, the method comprising:
time division multiplexing of WLAN and BT transmissions from a collocated WLAN system and a collocated BT system, respectively, the time division multiplexing including a WLAN period and a BT period, wherein
during the WLAN period, a high priority data signal from the collocated BT system causes the collocated WLAN system to enter a power-save mode and transmission/reception of the collocated BT system to be enabled.

13. The method of claim 12, wherein
the high priority data signal includes timing information of subsequent BT transmissions/receptions from a timing block of the collocated BT system.

14. The method of claim 12, wherein
the high priority data signal includes at least one of page, page scan, and master-slave switch information for build-up of a wireless personal area network (WPAN), and a sniff packet to determine WPAN association.

15. A method of wireless local area network/Bluetooth (WLAN/BT) coexistence for a collocated WLAN/BT device, the method comprising:
time division multiplexing of WLAN and BT transmissions from a collocated WLAN system and a collocated BT system, respectively, the time division multiplexing including a WLAN period and a BT period, wherein
during a BT period, the collocated BT system is idle and the collocated WLAN system transmits.

16. The method of claim 15, wherein
during an idled BT period, the collocated BT system enters a wake state or sniff.

17. A method of wireless local area network/Bluetooth (WLAN/BT) coexistence for a collocated WLAN/BT device, the method comprising:
time division multiplexing of WLAN and BT transmissions from a collocated WLAN system and a collocated BT system, respectively, the time division multiplexing including a WLAN period and a BT period, wherein
during a WLAN period, the collocated WLAN is idle and the collocated BT system transmits.

18. The method of claim 17, wherein
during an idled WLAN period, the collocated WLAN system transmits a Power-Save (PS)-Poll frameupon awakening or listens for beacon frames from the access point.
